(19) United States
(12) Patent Application Publication
(10) Pub. No.: US 2010/0310796 A1
(43) Pub. Date: Dec. 9, 2010

(54) INKJET RECORDING PAPER

(76) Inventors: Sei Nishiiri, Tokyo (JP); Yuji Sawa, Tokyo (JP); Koichi Yanai, Tokyo (JP); Nobuo Nakanishi, Tokyo (JP)

Correspondence Address: JENKINS, WILSON, TAYLOR & HUNT, P. A., 3100 Tower Blvd., Suite 1200, DURHAM, NC, 27707, US

(21) Appl. No.: 12/743,595

(22) PCT Filed: Nov. 18, 2008
(86) PCT No.: PCT/JP2008/070944

§ 371 Date: Aug. 27, 2010

(30) Foreign Application Priority Data
Nov. 19, 2007 (JP) 2007-298962

(51) Int. Cl. B41M 5/52

(52) U.S. Cl. 428/32.21

(57) ABSTRACT

An inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent, wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%.

### FIELD OF THE INVENTION

The present invention relates to a plain paper type inkjet recording paper having no ink-receiving layer containing a pigment.

### DESCRIPTION OF THE RELATED ART

Inkjet recording method involves attaching small ink droplets ejected by various mechanisms to a recording paper such as paper, thereby forming images or characters. This recording method has been widely used in homes since it can easily be conducted at high speed, provide full color prints, produce less noise upon printing, and the printer is low price. Meanwhile, in the commercial field, variable information (including public utility bills, credit card bills and receipts, shipping slips and advertisements) has been printed using non-impact printing (NIP). In recent years, a high speed inkjet printer having a line head has been replaced therewith.

The inkjet recording paper is roughly classified into a coated paper type on which an ink absorption layer is formed and a plain paper type on which no ink absorption layer containing a pigment is formed. The coated paper that can reproduce high resolution images is used to print outputs from digital cameras. The less expensive plain paper is mainly used for business reports, public utility bills, payment slips and the like. With wide-spreading the application of inkjet recording, a plain paper type inkjet recording paper that can inexpensively reproduce high resolution images is needed.

High brightness is needed for the plain paper type inkjet recording paper. When printing is made on the recording paper having high brightness, quality of color printing and character reproducibility become good. The inkjet recording paper should have a high anti-feathering property (to suppress ink bleeding on the paper) such that bar-codes can be read, a water-resistant property, and high ink drying property such that high-speed printing can be made.

Bar-codes represent required information including numbers, alphabets and symbols by juxtaposing alternately plural kinds of black and white bars having different widths at a predetermined combination pattern. Depending on the number and kinds in the black and white bars that are minimum units constituting the bar pattern, the bar-codes are classified into 1) a binary level (two-part level) where two, i.e., narrow and wide, bar widths exist and 2) a multi level where plural widths exist in black and white bars. The multi level bar-code can advantageously represent more information than the binary level bar-code, when the total lengths of binary and multi level bar-codes are the same. However, the multi level bar-code has almost no tolerance in the width ratio. When the anti-feathering property is low, the black and white bars become indistinguishable. As a result, reading errors by an optical reader might be increased. The multilevel bar-code standard GS1-128 is known. In recent years, the bar-codes on the payment slips of public utilities that can be handled in convenience stores have been standardized according to GS1-128. Accordingly, even higher anti-feathering property is needed in the inkjet recording paper.

Next, the ink drying property will be described. The high-speed inkjet printer involves an auxiliary dryer such as a microwave dryer, a high-frequency dryer, a cylinder dryer and a hot air dryer. However, these are auxiliary and have not sufficient drying ability. In the high-speed inkjet printer, the recording paper is printed at high speed such as at 100 m/min or more. So, the ink should be permeated and dried quickly on the recording paper after printing. When the plain paper having no ink absorption layer is used for the high-speed inkjet printer, the ink absorption property is especially important.

As to the plain paper type inkjet recording paper, Patent Literature 1 discloses a recording paper comprising a base paper containing a pulp fiber, a white inorganic mineral powder as a filler and a rosin based size emulsion as an internal sizing agent, wherein a size press liquid containing an aqueous polymer and a conductive agent is coated on the surface of the base paper.

Patent Literature 2 describes a sheet for use in a high speed rotary inkjet printing system, wherein a cationic resin is adhered to the sheet at a range of 0.2 to 2.0 g/m², and wherein Bristow absorption coefficient of the sheet is 1.07 to 1.90 (ml/m²·m^{1/2}).

Patent Literature 3 describes a composition for a coating paper comprising a fluorescent dye, a polymer obtained by polymerizing a monomer containing a diallyl dimethyl ammonium salt, a dye fixative and a specific cationic polymer; and an inkjet recording paper on which the composition is coated.

Patent Literature 4 describes a recording paper having color printing ability comprising precipitated calcium carbonate having either shape of needle, column, spindle or whisker and having an aspect ratio of 5 or more wherein the content of the precipitated calcium carbonate is 10 mass % based on the mass of the paper, and comprising alkenyl succinic anhydride as an internal sizing agent.

### [Patent Literature 1] Unexamined Japanese Patent Publication (Kokai) 2000-071606

### [Patent Literature 2] Unexamined Japanese Patent Publication (Kokai) Hei 09-202042

### [Patent Literature 3] Unexamined Japanese Patent Publication (Kokai) 2006-241626

### [Patent Literature 4] Unexamined Japanese Patent Publication (Kokai) 2005

### PROBLEMS TO BE SOLVED BY THE INVENTION

In the case of the technology described in Patent Literatures 1 through 4, both of the high anti-feathering property and the ink drying property to be intended cannot be obtained. When the anti-feathering property is added to the inkjet recording paper in order to enhance the inkjet printing quality and the inkjet recording paper is used in the high-speed inkjet printer at a printing speed of 100 m/min or more, some defects such as roll grime may be produced.

In the case of the technology described especially in Patent Literatures 1 and 2, the anti-feathering property is insufficient and recent high-definition bar-codes cannot be printed using the high-speed inkjet printer. In the case of the technology described in Patent Literature 3, four different cationic polymers and an anionic fluorescent dye should be mixed to provide the coating mixture, which is unstable and has poor coating ability. In the case of the technology described in Patent Literature 4, since calcium carbonate is used as a filler, some brightness can be obtained. However, the anti-feathering property and the water resistant property in the recording part are insufficient when the inkjet recording printing is conducted.

Therefore, the object of the present invention is to provide a plain paper type inkjet recording paper having high ink drying property, high anti-feathering property for printing high-definition bar-codes, water resistant property and high brightness.

### SUMMARY OF THE INVENTION

Through diligent studies, the present inventors solved the problems described above by providing an inkjet recording paper comprising a base paper containing pulp, rosette type precipitated calcium carbonate as a filler, and a neutral rosin sizing agent as an internal sizing agent, wherein the surface of the base paper is coated with a coating mixture containing at least a cationic resin, an anionic fluorescent dye and a binder.

The present invention provides an inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent, wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%. Preferably, the cationic resin is a polyamine epihalohydrin based resin, and the anionic fluorescent dye is a stilbene based fluorescent dye. Preferably, the cationic resin has a molecular weight of 10,000 or less, and the base paper is coated with the coating mixture using a transfer roll coater. Preferably, the base paper is made from a pulp slurry containing the pulp and the cationic resin.

According to the present invention, there is provided a plain paper type inkjet recording paper having high ink drying property, high anti-feathering property for printing high-definition bar-codes, water resistant property and high brightness. The base paper contains rosette type precipitated calcium carbonate as a filler, and a neutral rosin sizing agent as an internal sizing agent, whereby high anti-feathering property and ink drying property can be obtained even if there is no ink-receiving layer containing a pigment.

### BRIEF DESCRIPTION OF THE DRAWING

FIG. 1 is an electron micrograph showing a shape of secondary particles in rosette type precipitated calcium carbonate.

### DESCRIPTION OF THE PREFERRED EMBODIMENTS

An inkjet recording paper of the present invention is a plain paper type, and comprises a base paper containing a pulp, a filler and a sizing agent on which a coating solution containing a cationic resin and a fluorescent dye is coated. No ink receiving layer containing a pigment is disposed.

According to the present invention, when a coating mixture containing a polyamine epihalohydrin based resin, a stilbene based anionic fluorescent dye as the fluorescent dye and the binder is coated on the base paper, both of the brightness and the anti-feathering property can be obtained. Especially when a transfer roll coater is used to coat the base paper with the coating mixture, both surfaces have high inkjet recording printability (including the anti-feathering property and the ink drying property) and also have high surface strength. Thus, the inkjet recording paper having excellent printability can be stably produced with high productivity. In addition, since the base paper is made from a pulp slurry containing the pulp and the cationic resin, the anti-feathering property is further improved.

### 1. Base Paper

### <Pulp>

The base paper is made using wood pulp, filler and aids. The wood pulp includes known chemical pulp, mechanical pulp, deinking pulp and the like.

These can be used alone or in combination as required. Any known conventional pulp commonly used in making paper can be used. Examples are woodpulp including the chemical pulp such as bleached hard wood kraft pulp (LBKP), bleached soft wood kraft pulp (NBKP), bleached hard wood sulfite pulp (LBSP) and bleached soft wood sulfite pulp (NBSP); mechanical pulp such as goundwood pulp (GP) and thermomechanical pulp (TMP); and waste paper pulp (DIP). Also, non-wood pulp such as cotton pulp, hemp, bagasse, kenaf, esparto, Camellia japonica, Edgeworthia chrysantha and Diplomorpha sikokiana can be used.

### <Filler>

The filler contained in the base paper mainly comprises rosette type precipitated calcium carbonate. The rosette type precipitated calcium carbonate is made by aggregating radially primary particles of spindle-shaped precipitated calcium carbonate to form rosette type secondary particles. Specific examples include ALBACAR-HO, ALBACAR-5970 and ALBACAR-LO sold by Specialty Minerals Inc. The term “radially” means, for example, that each primary particle grows radially in a longitudinal direction from a center of each secondary particle.

The precipitated calcium carbonate is excellent in view of manufacturing costs and operability. Also, high brightness and opacity can be provided by adding only a small amount of the precipitated calcium carbonate. Since the rosette type precipitated calcium carbonate has a special shape, high oil absorption can be realized. By adding the rosette type precipitated calcium carbonate to the base paper, the ink absorption performance is significantly improved and the ink drying property is also significantly improved when the inkjet recording is conducted. Especially when a high-speed inkjet printer having a printing speed of 100 m/min or more is used, the rosette type precipitated calcium carbonate is very effective.

The ash content of the rosette type precipitated calcium carbonate in the inkjet recording paper is preferably 11 to 25% by weight measured according to JIS-P8251. When the weight of the rosette type precipitated calcium carbonate is under 11% by weight to absolute dry pulp mass, the ink drying property may be poor. In contrast, when the weight of the rosette type precipitated calcium carbonate exceeds 25% by weight to absolute dry pulp mass, powder may drop and the anti-feathering property may be poor.

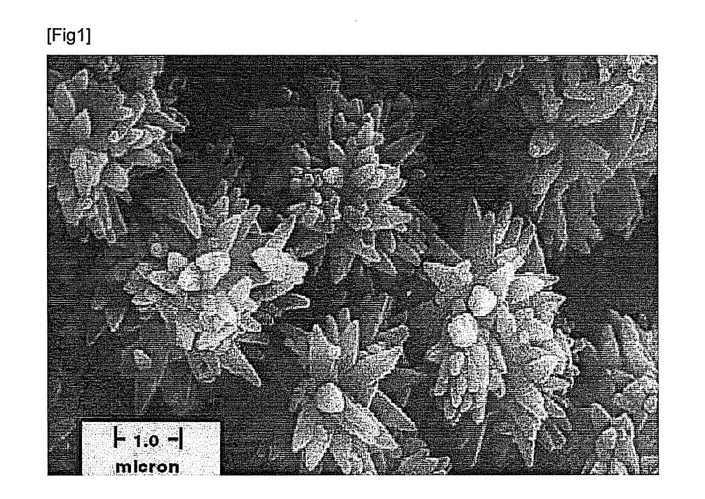

FIG. 1 is an electron micrograph showing an example of the rosette type precipitated calcium carbonate (secondary particles) dispersed in the liquid. In the Figure, the bottoms of the primary particles are aggregated and the primary particles grow radially to their tips. The primary particles have some large wide (diameter) bottoms and become thin toward the tips. In the FIGURE, the micron means μm.

Along with the rosette type precipitated calcium carbonate, any conventional inorganic fine particles commonly used can be used as the filler. Examples include non-rosette type precipitated calcium carbonate, ground calcium carbonate, kaolin, talc, silica, white carbon, aluminum hydroxide, zeolite and the like. The amount of such inorganic fine particles is preferably about 20% by weight or less based on the total amount of the filler.

### <Internal Sizing Agent>

According to the present invention, the internal sizing agent is a neutral rosin sizing agent. Other than the neutral rosin sizing agent, the sizing agent used in a neutral range when precipitated calcium carbonate is used as the filler may be alkenyl succinic anhydride (ASA) and alkyl ketene dimer (AKD). However, when alkyl ketene dimer is used, a friction coefficient of the paper is decreased and the paper may be slipped during printing and post-processing. When alkenyl succinic anhydride is used, the sizing effect is greatly affected by other additives used in papermaking, and the handling is difficult to provide stable quality. Accordingly, the neutral rosin sizing agent is used, since it can provide stable sizing effect and the paper is not slipped.

The amount of the neutral rosin sizing agent in the base pulp is preferably 0.2 to 2.5% by weight, more preferably 0.5 to 2.0% by weight to the base pulp. When the amount is under 0.2% by weight, sufficient sizing effect may not be provided. In contrast, when the amount exceeds 2.5% by weight, the ink drying property of the paper may be poor when it is printed using the inkjet printer.

The neutral rosin sizing agent for use in the present invention is used in a weak acid to weak alkali range (neutral range) at pH 6 to 9, and is an emulsion type rosin sizing agent in which a rosin-based material is dispersed by an emulsifying dispersant. Examples of the rosin-based material include fortified rosins obtained by modifying rosins such as gum rosin, wood rosin and tall oil rosin with α, β-unsaturated carboxylic acids such as fumaric acid, maleic acid and acrylic acid or an anhydride thereof; and rosin ester obtained by reacting the rosins with polyhydric alcohols such as glycerin, trimethylolethane, trimethylolpropane, pentaerythritol and diglycerin. The rosin-based material can be used alone, or in combination in an emulsified form. Also, the rosin-based material may be emulsified alone, and then combined. In order to further improve the sizing effect, various polymers may be added to the rosin emulsion.

### <Making a Base Paper>

Any known paper machines including Fourdrinier paper machine, twin wire paper machine and Yankee paper machine can be used for making a base paper, as required. Of these, the twin wire paper machine is particularly preferable, because both top and bottom of the base pulp slurry are dewatered to decrease a composition difference between both sides of the paper. In order to provide the inkjet recording paper according to the present invention, the paper making conditions including pulp freeness, a jet/wire ratio, a profile, a press and calendar and the drying conditions including a vapor pressure and ventilation at a dryer of the paper machine are adjusted. Any known adjusting methods can be utilized. The pH upon the paper making can be the acid to alkali range. Preferably, the pH is 6 to 9, i.e., weak acid to weak alkali range (neutral range). Any internal agent for making paper such as a paper strengthening additive, an antifoaming agent, a pH adjusting agent, a yield improving agent, a dye and a colored pigment for adjusting a color hue, a fluorescent dye for improving visible whiteness and the like can be added thereto within the ranges that do not adversely affect on the effect of the present invention.

### <Adding Cationic Resin>

According to the present invention, the above-mentioned base pulp slurry preferably contains the cationic resin as described later, which can improve the sizing effect and the anti-feathering property. The cationic resin may be directly added to the base pulp slurry. Alternatively, disintegrate a broke of inkjet recording paper that is not a commodity product and is made during the production and the finishing of the inkjet recording paper according to the present invention, and then this disintegrated slurry is added to the base pulp slurry. Preferably, the amount of the pulp slurry containing the cationic resin made by disintegrating the broke of paper is 5% by weight or more at a pulp absolute dry mass. When the broke of paper is used, the cationic resin can be effectively added to the paper as compared with the direct addition of the cationic resin to the base pulp slurry. It is economical in that the broke of paper can be recycled for producing new paper.

### 2. Coating Mixture

### <Cationic Resin>

In the present invention, the coating mixture contains the cationic resin as an effective ink fixing agent to provide the anionic inkjet ink with water resistance and to improve the anti-feathering property.

The cationic resin is a cationic water soluble polymer. Preferably, the cationic resin has a molecular weight of 200,000 or less from the standpoint of improving the anti-feathering property and the ink water resistance. When the cationic resin is used in the inkjet recording paper according to the present invention, the molecular weight of the cationic resin is preferably 10,000 or less.

Furthermore, the cation density of the cationic resin is preferably 5 meq/g or more. When the cation density is less than 5 meq/g, the ink fixing capability may be insufficient.

The molecular weight is a mass average molecular weight measured by GPC (Gel Permeation Chromatography). The cation density is measured by a general colloid titration method using (1/400) N potassium polyvinyl sulfate (PVSK) solution as a titrant and 0.1% toluidine blue solution as an indicator, and calculated by the following equation.

Cation density (meq/g)=(PVSK titer (ml)/400)/{(cationic polymer compound solution collection quantity (g))×(cationic polymer compound solution concentration (% by weight)/100)} [Equation 1]

Examples of the cationic resin include polyethylene imine quaternary ammonium salt derivatives; ammonia-dialkylamine-epichlorohydrin resins; polyamine epihalohydrin; polyamide epihalohydrin; polyamine polyamide epihalohydrin, dicyanamide-formaldehyde resins; diethylenetriamine-dicyandiamide-ammonium chloride resins; dimethyldiallyl ammonium chloride resins and the like. Of these, polyamine epihalohydrin-based resins obtained by condensation polymerization of ammonia, amines and epihalohydrins are particularly preferable due to the excellent anti-feathering property obtained when the high speed inkjet printer is used to print, as described later.

Primary amines, secondary amines, tertiary amines, polyalkylene polyamines and alkanolamine monoamines can be cited as the amines used in the resin mentioned above. More specifically, as the secondary amine dimethylamine, diethylamine, dipropylamine, methyl ethylamine, methyl propylamine, methyl butylamine, methyl octylamine, methyl laurylamine, dibenzylamine and the like can be cited. More specifically, as the tertiary amine trimethylamine, triethylamine, tripropylamine, tri-isopropylamine, tri-n-butylamine, tri-sec-butylamine, tri-tert-butylamine, tripentylamine, trihexylamine, trioctylamine and tribenzylamine can be cited. Of these dimethylamine and diethylamine, which are secondary amines, are particularly preferable.

As the epihalohydrins in the resin described above, at least one or more selected from epichlorohydrin, epibromohydrin, epi-iodohydrin, methyl epichlorohydrin and the like can be used. Of these, epichlorohydrin is preferably used.

A well known method, for example, the one described in Unexamined Japanese Patent Publications (Kokai) Hei 10-152544 and Hei 10-147057, can be used as a synthetic method for the resin mentioned above. The resin may be added alone to the coating mixture for the ink-receiving layer. Or, the resins having different degrees of polymerization may be mixed and added to the coating mixture. In addition, the resin may be obtained by appropriate synthesis, or a commercially available product resin may also be used.

According to the present invention, the coating weight of the cationic resin at both sides is preferably from 0.5 g/m² to 5.0 g/m², more preferably 1.0 g/m² to 3.0 g/m². When the coating weight at both sides is less than 0.5 g/m², the anti-feathering property and the water-resistant property become insufficient. When the coating weight of the cationic resin at both sides exceeds 5.0 g/m², the anti-feathering property and the water-resistant property are no more improved. In addition, the excess coating is not preferable as the material costs increase.

### <Fluorescent Dye>

According to the present invention, it is preferable that the fluorescent dye is added to the coating mixture in order to provide high brightness. Examples of the fluorescent dye include diaminostilbene based, imidazole based, oxazol based, triazole based, courmarine based, naphthalimide based and pyrazoline based fluorescent dyes. In general, anionic fluorescent dyes are incompatible with cationic resins, aggregates are produced when they are mixed. In the present invention, diaminostilbene based fluorescent dye is particularly preferable because it is highly compatible with the above-mentioned cationic resin and provides high brightness.

### <Binder>

The binder in the coating mixture is not especially limited and can appropriately be selected from, for example, well known resins. Preferably, the binder is soluble or dispersible in water such as a water soluble polymer adhesive, a synthetic emulsion type adhesive and the like. As the water soluble polymer adhesive, starch and its modifications, poly(vinyl alcohol) and its modifications, casein and the like may be cited. In addition, acrylic resin based emulsion, vinyl acetate resin based emulsion, styrene butadiene latex, urethane resin based emulsion and the like may be cited as the synthetic emulsion type adhesive. However, the use of the water soluble polymer adhesive is desirable from the standpoint of the optical density. Specific examples of the binder include completely saponified poly(vinyl alcohol), partially saponified poly(vinyl alcohol), cation modified poly(vinyl alcohol), anion modified poly(vinyl alcohol), silanol modified poly(vinyl alcohol), oxidized starch, hydroxyethyl etherified starch, phosphoric acid esterified starch and the like.

### <Other Components>

Other components such as a sizing agent, a dye, a water retention agent, a water resistant agent (insolubilizer) a pH adjusting agent, an antifoaming agent, a lubricant, a preservative, a surfactant, a conductive agent, an ultraviolet ultraviolet radiation absorber, an antioxidant and the like can be added to the coating mixture within the ranges that do not adversely affect on the effect of the present invention.

### <Coating Method>

According to the present invention, the coating mixture is preferably coated on the base paper at a high speed (300 m/min or more, possibly 1000 m/min or more) using a transfer roll coater. With such a coating method, both surfaces of the base paper can be coated at the same time and the transfer roll coater can be easily mounted on the paper machine. Thus, the productivity is significantly increased. By coating both surfaces of the base paper at the same time, it is possible to produce double-sided printable inkjet recording paper at low costs. Examples of the transfer roll coater include a gate roll coater, a rod metering size press, a blade metering size press and the like. These coaters apply the coating mixture to the base paper in a pre-metering method (print roll coating). In other words, the coating mixture is metered using a plurality of rolls, bars and blades, which is then applied to the base paper using an application roll. The coater in the pre-metering method has advantages in that a less load is applied to the base paper when the base paper is coated and therefore the base paper is hardly broken, and the coating can be performed at higher speed, as compared with a coater in a post-metering method such as a blade coater and a bar boater, i.e., the coating mixture applied to the base paper is scraped out. Using the transfer coater, the thickness of the coating layer formed on the base paper becomes uniform, thereby further improving the anti-feathering property.

In the present invention, the transfer roll coater may be an on-machine or off-machine coater. The on-machine coater is mounted on the manufacturing machine of the base paper (paper machine and the like), and applies the coating in the same line as the manufacturing line of the base paper. The off-machine coater is mounted separately from the manufacturing machine of the base paper, and applies the coating to the manufactured and role upped base paper in a separate line from the manufacturing line of the base paper. In order to improve the productivity and to reduce costs, the on-machine transfer roll coater is preferably used.

In the traditional inkjet recording paper is manufactured in a coating method using a blade coater, an air knife coater, a bar coater, a curtain coater and the like. With such a coating method, it is difficult to coat both surfaces of the base paper at the same time. To coat both surfaces, manufacturing steps are increased and a drying load is increased, and it is impractical.

### <Ash Content>

The inkjet recording paper of the present invention should have an ash content of 13% to 25%, preferably 14% to 20% as determined by JIS-P8251. When the ash content is within 13% to 25%, the ink drying property is improved upon the inkjet recording. When the ash content is less than 13%, the advantage cannot obtain. When the ash content exceeds 25%, it cannot control over spreading of the ink in a cross direction of the recording paper, the ink may easily bleed, and the anti-feathering property may be worse. According to JIS-P8251, the ash content is expressed by percentage of a residue weight of ash after burning at a temperature of 525+/−25° C. to absolute dry mass of a sample.

### <Stockigt Size Degree>

According to the present invention, the base paper contains a neutral rosin sizing agent as an internal sizing agent, and rosette type precipitated calcium carbonate as an internal filler, whereby the sizing effect can be provided, while high ink absorption performance is kept. The inkjet recording paper should also have 10 to 25 seconds of a Stockigt size degree as determined by JIS-P8122. In order to provide both of the anti-feathering property and the ink absorption performance at a high level, the Stockigt size degree is more preferably 12 to 20 seconds. When the Stockigt size degree is less than 10 seconds, the jetted ink may easily spread in a cross direction of the recording paper, and the anti-feathering property may be significantly decreased. When the Stockigt size degree exceeds 25 seconds, the anti-feathering property is good, but the ink drying property is significantly decreased, and the inkjet printing paper is difficult to be used in the high-speed inkjet printer.

The Stockigt size degree can be adjusted by the content of the internal sizing agent in the base paper, and the coating weight of each component in the coating mixture. For example, when the contents of the internal sizing agent and the cationic resin in the base paper are increased, the size degree is increased. When the content of the cationic resin is increased, the size degree is decreased.

### <Printer>

The high-speed inkjet printer for use in the present invention is a roll paper feed type printer having a printing speed of 100 m/min or more. The inkjet printer has a line head for each ink color, and can print at high speed. Ink for use in the high-speed inkjet printer is water-based dye type ink or water-based pigment type ink. The high-speed inkjet printer includes an auxiliary dryer such as a microwave dryer, a high-frequency dryer, a cylinder dryer and a hot air dryer. Specific examples of the high-speed inkjet printer include VX5000e manufactured by Kodak versamark inc., ISETO Super Jet 4000 manufactured by ISETO Corporation, MJP600 manufactured by Miyakoshi, Inc. SCITEX6240 manufactured by SCITEX Corporation Ltd. and the like.

### EXAMPLES

The present invention is explained in further detail by presenting specific examples below, but the present invention is not limited by these examples. In addition, terms “parts” and “%” described below refer to “parts by weight” and “% by weight”, respectively, unless otherwise noted.

### Example 1

To a pulp slurry including 100% of hardwood kraft pulp (freeness 360 ml c.s.f.), 20% of rosette type precipitated calcium carbonate (ALBACAR-5970 manufactured by SMI Inc.) as a filler to absolute dry pulp mass, 1.2% of aluminum sulfate, 1.0% of a neutral rosin sizing agent (CC1401 manufactured by SEIKO PMC CORPORATION) as an internal sizing agent and 0.7% of cationic starch (CAT0304 manufactured by Nippon NSC Ltd.) were added to provide a base slurry. The slurry was processed by a twin wire paper machine at a speed of 800 m/min to make a base paper at a basis weight of 80 g/m². On both surfaces of the base paper, a coating mixture comprising 10.0% of oxidized starch (MS #3600 manufactured by NIHON SHOKUHIN KAKO CO., LTD), 4.0% of polyamine epihalohydrin based resin having a molecular weight of several thousands (DK6802, cationic resin manufactured by SEIKO PMC CORPORATION) and 0.3% of stilbene based fluorescent dye (Kyaphor PASQ Liquid manufactured by NIPPON KAYAKU Co., Ltd.) was applied to both surfaces at 7 g/m² using a rod metering size press to produce an inkjet recording paper 1.

### Example 2

A pulp slurry including 100% of hardwood kraft pulp (freeness 360 ml c.s.f.) was mixed with a slurry (which becomes a pulp slurry including a cationic resin) obtained by disintegrating a broke of inkjet recording paper 1 in Example 1 at an absolute dry pulp mass ratio of 85:15 to provide a mixed pulp slurry. To the mixed pulp slurry, 20% of rosette type precipitated calcium carbonate (ALBACAR-5970 manufactured by SMI Inc.) as a filler to absolute dry pulp mass, 1.2% of aluminum sulfate, 1.0% of a neutral rosin sizing agent (CC1401 manufactured by SEIKO PMC CORPORATION) as an internal sizing agent and 0.7% of cationic starch (CAT0304 manufactured by Nippon NSC Ltd.) were added to provide a base slurry. The slurry was processed by a twin wire paper machine at a speed of 800 m/min to make a modified base paper at a basis weight of 80 g/m². The above-described coating mixture was applied in the same manner described in Example 1 with the exception that the modified base paper was used to produce an inkjet recording paper 2.

### Example 3

An inkjet recording paper 3 was produced in the same manner described in Example 2 with the exception that the amount of the neutral rosin sizing agent to the pulp slurry was changed to 1.5% wherein the neutral rosin sizing agent was added in the base paper.

### Example 4

An inkjet recording paper 4 was produced in the same manner described in Example 2 with the exception that the amount of the neutral rosin sizing agent to the pulp slurry was changed to 0.5% wherein the neutral rosin sizing agent was added in the base paper.

### Example 5

An inkjet recording paper 5 was produced in the same manner described in Example 2 with the exception that the amount of the rosette type precipitated calcium carbonate to the pulp slurry was changed to 37% and the amount of the neutral rosin sizing agent to the pulp slurry was changed to 1.7%, wherein the rosette type precipitated calcium carbonate and the neutral rosin sizing agent were added in the base paper.

### Example 6

An inkjet recording paper 6 was produced in the same manner described in Example 2 with the exception that the amount of the rosette type precipitated calcium carbonate to the pulp slurry was changed to 17% and the amount of the neutral rosin sizing agent to the pulp slurry was changed to 1.0%, wherein the rosette type precipitated calcium carbonate and the neutral rosin sizing agent were added in the base paper.

### Example 7

An inkjet recording paper 7 was produced in the same manner described in Example 2 with the exception that the amount of the polyamine epihalohydrin based resin to the coating mixture was changed to 2.5%.

### Example 8

An inkjet recording paper 8 was produced in the same manner described in Example 2 with the exception that the polyamine epihalohydrin based resin was not added and 4.0% of a polyamine epihalohydrin based resin having a molecular weight of several tens of thousands (DK6854 manufactured by SEIKO PMC CORPORATION) was added to the coating mixture.

### Comparative Example 1

An inkjet recording paper 9 was produced in the same manner described in Example 2 with the exception that the amount of the neutral rosin sizing agent to the pulp slurry was changed to 0.3% wherein the neutral rosin sizing agent was added in the base paper.

### Comparative Example 2

An inkjet recording paper 10 was produced in the same manner described in Example 2 with the exception that the amount of the neutral rosin sizing agent to the pulp slurry was changed to 2.0% wherein the neutral rosin sizing agent was added in the base paper.

### Comparative Example 3

An inkjet recording paper 11 was produced in the same manner described in Example 2 with the exception that above-mentioned neutral rosin sizing agent was not added, and 0.20% of an alkyl ketene dimer (AD1604 manufactured by SEIKO PMC CORPORATION) was added as the internal sizing agent for the base paper.

### Comparative Example 4

An inkjet recording paper 12 was produced in the same manner described in Example 2 with the exception that above-mentioned neutral rosin sizing agent was not added, and 0.25% of emulsion obtained by emulsifying alkenyl succinic anhydride (AS1532 manufactured by SEIKO PMC CORPORATION) with a polymer sizing agent (SP1800 manufactured by SEIKO PMC CORPORATION) was added as the internal sizing agent for the base paper.

### Comparative Example 5

An inkjet recording paper 13 was produced in the same manner described in Example 2 with the exception that the fluorescent dye was not added to the coating mixture.

### Comparative Example 6

An inkjet recording paper 14 was produced in the same manner described in Example 2 with the exception that the polyamine epihalohydrin based resin was not added to the coating mixture.

### Comparative Example 7

An inkjet recording paper 15 was produced in the same manner described in Example 2 with the exception that the amount of the rosette type precipitated calcium carbonate to the pulp slurry was changed to 12% and the amount of the neutral rosin sizing agent to the pulp slurry was changed to 0.7%, wherein the rosette type precipitated calcium carbonate and the neutral rosin sizing agent were added in the base paper.

### Comparative Example 8

An inkjet recording paper 16 was produced in the same manner described in Example 2 with the exception that the amount of the rosette type precipitated calcium carbonate to the pulp slurry was changed to 43% and the amount of the neutral rosin sizing agent to the pulp slurry was changed to 2.0%, wherein the rosette type precipitated calcium carbonate and the neutral rosin sizing agent were added in the base paper.

### Comparative Example 9

An inkjet recording paper 17 was produced in the same manner described in Example 2 with the exception that the rosette type precipitated calcium carbonate was not added and 20% of spindle-shaped precipitated calcium carbonate (PC manufactured by SHIRAISHI KOGYO KAISHA, LTD.) was added to the pulp slurry to produce the base paper.

### <Evaluation—Properties of the Inkjet Recording Paper>

Ash Content

According to JIS-P8251, the ash content of each inkjet recording paper was measured at 525° C.

ISO Brightness

According to JIS-P8148 (ISO 2470), ISO brightness (UV-in) of each inkjet recording paper was measured. When the brightness exceeds 90%, the brightness is sufficiently high, and there is no problem.

Stockigt Size Degree

According to JIS-P8122, the Stockigt size degree of each inkjet recording paper was measured.

Traveling Performance

The resultant inkjet recording paper was passed through a roll paper feed type offset printer at a paper speed of 100 m/min to visually inspect the traveling performance of paper slippage, flapping and powder drop. When the following evaluation is O or Δ, there is no practical problem upon the inkjet recording using the roll paper feed type printer printed at a speed of 100 m/min or more.

O: Very good (almost no paper slippage, flapping and powder drop)
Δ: Good (some paper slippage, flapping or powder drop)
X: Not good (apparent paper slippage, flapping or powder drop)
<Inkjet Recording with Water-Based Ink>

Each recording paper was inkjet printed using the inkjet printer, SCITEX6240 system printer (manufactured by SCITEX Corporation Ltd., paper speed of 100 m/min, high-speed inkjet printer) with a black ink (#1040). The inkjet recording printability was evaluated for the following items. The evaluation results are shown in Table.

### <Evaluation Items in the Inkjet Recording Printability>

Anti-Feathering Property

A fine line pattern (0.1 mm width×35 mm height×500 lines) was printed on the printing paper to visually inspect for line bleeding. When the following evaluation result is O or Δ, there is no practical problem.

O: No bleeding
Δ: Some bleeding
X: marked bleeding in a unpractical level

Water-Resistant Property

A black solid pattern 1 (50 mm width×15 mm height) was printed on the printing paper and the printing paper was immersed in distilled water to visually inspect for the water-resistance property from the standpoint of ink flow. When the following evaluation result is O or Δ, there is no practical problem.

O: No ink flow
Δ: Some ink flow
X: marked ink flow

Ink Drying Property

A black solid pattern 2 (85 mm width×5 mm height) was printed on the printing paper and the solid part was rubbed with fingers to measure the time to dryness. When the following evaluation result is O or Δ, there is no practical problem.

O: time taken to achieve dryness was less than 5 seconds
Δ: time taken to achieve dryness was 5 to 10 seconds
X: time taken to achieve dryness exceeded 10 seconds Table 1 shows the evaluated results of each inkjet recording paper in Examples 1 to 8 and Comparative Examples 1 to 9 according to the above-described evaluation methods.

TABLE 1

| | | Structure | | | | |
|---|---|---|---|---|---|---|
| | | | | | | Fluores- |
| | | Internal | | | Cationic | cent |
| | | sizing agent | Broke | Filler type | Rsin | dye |
| Ex. 1 | Recording | Neutral rosin | — | Rosette type precipitated | DK6802 | PASQ |
| | medium 1 | 1.0% | | calcium carbonate | 4.0% | 0.3% |
| | | | | 20% | | |
| Ex. 2 | Recording | Neutral rosin | 15% | Rosette type precipitated | DK6802 | PASQ |
| | medium 2 | 1.0% | | calcium carbonate | 4.0% | 0.3% |
| | | | | 20% | | |
| Ex. 3 | Recording | Neutral rosin | 15% | Rosette type precipitated | DK6802 | PASQ |
| | medium 3 | 1.5% | | calcium carbonate | 4.0% | 0.3% |
| | | | | 20% | | |
| Ex. 4 | Recording | Neutral rosin | 15% | Rosette type precipitated | DK6802 | PASQ |
| | medium 4 | 0.5% | | calcium carbonate | 4.0% | 0.3% |
| | | | | 20% | | |
| Ex. 5 | Recording | Neutral rosin | 15% | Rosette type precipitated | DK6802 | PASQ |
| | medium 5 | 1.7% | | calcium carbonate | 4.0% | 0.3% |
| | | | | 37% | | |
| Ex. 6 | Recording | Neutral rosin | 15% | Rosette type precipitated | DK6802 | PASQ |
| | medium 6 | 1.0% | | calcium carbonate | 4.0% | 0.3% |
| | | | | 17% | | |
| Ex. 7 | Recording | Neutral rosin | 15% | Rosette type precipitated | DK6802 | PASQ |
| | medium 7 | 1.0% | | calcium carbonate | 2.5% | 0.3% |
| | | | | 20% | | |
| Ex. 8 | Recording | Neutral rosin | 15% | Rosette type precipitated | DK6854 | PASQ |
| | medium 8 | 1.0% | | calcium carbonate | 4.0% | 0.3% |
| | | | | 20% | | |
| Comp. Ex. 1 | Recording | Neutral rosin | 15% | Rosette type precipitated | DK6802 | PASQ |
| | medium 9 | 0.3% | | calcium carbonate | 4.0% | 0.3% |
| | | | | 20% | | |
| Comp. Ex. 2 | Recording | Neutral rosin | 15% | Rosette type precipitated | DK6802 | PASQ |
| | medium 10 | 2.0% | | calcium carbonate | 4.0% | 0.3% |
| | | | | 20% | | |
| Comp. Ex. 3 | Recording | AKD | 15% | Rosette type precipitated | DK6802 | PASQ |
| | medium 11 | 0.20% | | calcium carbonate | 4.0% | 0.3% |
| | | | | 20% | | |
| Comp. Ex. 4 | Recording | ASA | 15% | Rosette type precipitated | DK6802 | PASQ |
| | medium 12 | 0.25% | | calcium carbonate | 4.0% | 0.3% |
| | | | | 20% | | |
| Comp. Ex. 5 | Recording | Neutral rosin | 15% | Rosette type precipitated | DK6802 | — |
| | medium 13 | 1.0% | | calcium carbonate | 4.0% | |
| | | | | 20% | | |
| Comp. Ex. 6 | Recording | Neutral rosin | 15% | Rosette type precipitated | — | PASQ |
| | medium 14 | 1.0% | | calcium carbonate | | 0.3% |
| | | | | 20% | | |
| Comp. Ex. 7 | Recording | Neutral rosin | 15% | Rosette type precipitated | DK6802 | PASQ |
| | medium 15 | 0.7% | | calcium carbonate | 4.0% | 0.3% |
| | | | | 12% | | |
| Comp. Ex. 8 | Recording | Neutral rosin | 15% | Rosette type precipitated | DK6802 | PASQ |
| | medium 16 | 2.0% | | calcium carbonate | 4.0% | 0.3% |
| | | | | 43% | | |
| Comp. Ex. 9 | Recording | Neutral rosin | 15% | spindle-shaped precipitated | DK6802 | PASQ |
| | medium 17 | 1.0% | | calcium carbonate | 4.0% | 0.3% |
| | | | | 20% | | |

| | Paper property | | | | Inkjet recording printability | | |
|---|---|---|---|---|---|---|---|
| | | | Stockigt | Printer | | Water | |
| | Ash | ISO | size degree | traveling | Anti- | resistant | Ink drying |
| | content (%) | brightness (%) | (sec) | performance | feathering | property | property |
| Ex. 1 | 15.3 | 93.3 | 12 | ∘ | Δ | ∘ | ∘ |
| Ex. 2 | 15.1 | 93.4 | 16 | ∘ | ∘ | ∘ | ∘ |
| Ex. 3 | 15.2 | 93.6 | 24 | ∘ | ∘ | ∘ | Δ |
| Ex. 4 | 15.0 | 93.2 | 11 | ∘ | Δ | ∘ | ∘ |
| Ex. 5 | 24.5 | 94.5 | 10 | ∘ | Δ | ∘ | ∘ |
| Ex. 6 | 13.2 | 92.0 | 20 | ∘ | ∘ | ∘ | Δ |
| Ex. 7 | 15.1 | 93.8 | 18 | ∘ | Δ | Δ | ∘ |
| Ex. 8 | 15.1 | 92.7 | 15 | ∘ | ∘ | Δ | ∘ |
| Comp. Ex. 1 | 15.0 | 93.4 | 6 | ∘ | x | ∘ | ∘ |
| Comp. Ex. 2 | 15.2 | 93.5 | 29 | ∘ | ∘ | ∘ | x |
| Comp. Ex. 3 | 14.9 | 92.5 | 11 | x | Δ | ∘ | ∘ |
| | | | | (Paper slippage) | | | |
| Comp. Ex. 4 | 14.9 | 93.0 | 9 | ∘ | x | ∘ | ∘ |
| Comp. Ex. 5 | 15.1 | 88.6 | 14 | ∘ | ∘ | ∘ | ∘ |
| Comp. Ex. 6 | 15.1 | 94.5 | 18 | ∘ | x | x | ∘ |
| Comp. Ex. 7 | 9.5 | 90.2 | 16 | ∘ | Δ | ∘ | x |
| Comp. Ex. 8 | 27.5 | 95.0 | 10 | x | x | ∘ | ∘ |
| | | | | (Powder drop) | | | |
| Comp. Ex. 9 | 15.2 | 91.1 | 15 | ∘ | ∘ | ∘ | x |

The recording paper 1 to 8 in Examples 1 to 8 according to the present invention had high brightness, excellent traveling performance through the printer, good inkjet recording printability (anti-feathering property, water-resistant property and ink drying property).

In contrast, in Comparative Example 1 containing a lesser amount of the neutral rosin sizing agent in the base paper as compared with each Example and having Stockigt size degree of less than 10 seconds, the anti-feathering property was significantly deteriorated. In Comparative Example 2 containing a greater amount of the neutral rosin sizing agent in the base paper as compared with each Example and having Stockigt size degree of exceeding 25 seconds, the ink drying property was significantly deteriorated.

In Comparative Example 3 containing alkyl ketene dimer in place of the neutral rosin sizing agent, the paper slippage occurred and the traveling performance through the printer was deteriorated. In Comparative Example 4 containing alkenyl succinic anhydride in place of the neutral rosin sizing agent, the anti-feathering property was significantly deteriorated.

In Comparative Example 5 containing no fluorescent dye, the brightness was significantly decreased. In Comparative Example 6 containing no cationic resin that is required for providing inkjet printing capability, the anti-feathering property and the water-resistant property were deteriorated.

In Comparative Example 7 containing a lesser amount of the rosette type precipitated calcium carbonate in the base paper as compared with each Example, the ink drying property was significantly deteriorated. In Comparative Example 8 containing a greater amount of the rosette type precipitated calcium carbonate in the base paper as compared with each Example, the powder was dropped and the anti-feathering property was significantly deteriorated. In Comparative Example 9 containing the spindle-shaped precipitated calcium carbonate in place of the rosette type precipitated calcium carbonate, the ink drying property was significantly deteriorated.

What is claimed is:

1. An inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent, wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%.

2. The inkjet recording paper according to claim 1, wherein the cationic resin is a polyamine epihalohydrin based resin, and the anionic fluorescent dye is a stilbene based fluorescent dye.

3. The inkjet recording paper according to claim 1, wherein the cationic resin has a molecular weight of 10,000 or less.

4. The inkjet recording paper according to claim 1, wherein the base paper is coated with the coating mixture using a transfer roll coater.

5. The inkjet recording paper according to claim 1, wherein the base paper is made from a pulp slurry containing the pulp and the cationic resin.

6. The inkjet recording paper according to claim 5, wherein the pulp slurry containing the cationic resin is produced by disintegrating a broke of inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent, wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%.

7. The inkjet recording paper according to claim 2, wherein the cationic resin has a molecular weight of 10,000 or less.

8. The inkjet recording paper according to claim 2, wherein the base paper is coated with the coating mixture using a transfer roll coater.

9. The inkjet recording paper according to claim 3, wherein the base paper is coated with the coating mixture using a transfer roll coater.

10. The inkjet recording paper according to claim 7, wherein the base paper is coated with the coating mixture using a transfer roll coater.

11. The inkjet recording paper according to claim 2, wherein the base paper is made from a pulp slurry containing the pulp and the cationic resin.

12. The inkjet recording paper according to claim 3, wherein the base paper is made from a pulp slurry containing the pulp and the cationic resin.

13. The inkjet recording paper according to claim 4, wherein the base paper is made from a pulp slurry containing the pulp and the cationic resin.

14. The inkjet recording paper according to claim 7, wherein the base paper is made from a pulp slurry containing the pulp and the cationic resin.

15. The inkjet recording paper according to claim 8, wherein the base paper is made from a pulp slurry containing the pulp and the cationic resin.

16. The inkjet recording paper according to claim 9, wherein the base paper is made from a pulp slurry containing the pulp and the cationic resin.

17. The inkjet recording paper according to claim 10, wherein the base paper is made from a pulp slurry containing the pulp and the cationic resin.

18. The inkjet recording paper according to claim 5, wherein the pulp slurry containing the cationic resin is produced by disintegrating a broke of inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent,
wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%; and
wherein the cationic resin is a polyamine epihalohydrin based resin, and the anionic fluorescent dye is a stilbene based fluorescent dye.

19. The inkjet recording paper according to claim 5, wherein the pulp slurry containing the cationic resin is produced by disintegrating a broke of inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent,
wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%;
wherein the cationic resin is a polyamine epihalohydrin based resin, and the anionic fluorescent dye is a stilbene based fluorescent dye, and;
wherein the cationic resin has a molecular weight of 10,000 or less.

20. The inkjet recording paper according to claim 5, wherein the pulp slurry containing the cationic resin is produced by disintegrating a broke of inkjet recording paper for use in a roll paper feed type printer having a printing speed of 100 m/min or more, comprising a base paper containing pulp, rosette type precipitated calcium carbonate as a filler, and a neutral rosin sizing agent as an internal sizing agent,
wherein the base paper is coated with a coating mixture containing a cationic resin, an anionic fluorescent dye and a binder but no pigment; the inkjet recording paper having a Stockigt size degree according to JIS-P8122 of 10 to 25 seconds and an ash content according to JIS-P8251 of 13% to 25%;
wherein the cationic resin is a polyamine epihalohydrin based resin, and the anionic fluorescent dye is a stilbene based fluorescent dye;
wherein the cationic resin has a molecular weight of 10,000 or less; and
wherein the base paper is coated with the coating mixture using a transfer roll coater.
